(19) United States
(12) Patent Application Publication
(10) Pub. No.: US 2014/0104674 A1
(43) Pub. Date: Apr. 17, 2014

(54) DISPLAY MEDIUM AND MANUFACTURING METHOD THEREOF AND ELECTROPHORETIC DISPLAY THEREWITH

(71) Applicant: SIPIX TECHNOLOGY INC., Taoyuan County (TW)

(72) Inventors: Wei-Ho Ting, Taichung City (TW); Ning-Wei Jan, New Taipei City (TW); Hui Du, Milpitas, CA (US); Hong-Mei Zang, Fremont, CA (US); Tyau-Jeen Lin, Taipei City (TW); Chun-Hsien Chen, Hsinchu County (TW)

(73) Assignee: SIPIX TECHNOLOGY INC., Taoyuan County (TW)

(21) Appl. No.: 13/651,483

(22) Filed: Oct. 15, 2012

(51) Int. Cl. G02F 1/167; C08F 220/68; H01B 1/12; C08F 220/22

(52) U.S. Cl. 359/296; 525/326.2; 525/104; 252/500

(57) ABSTRACT

A display medium adapted for an electrophoretic display is provided. The display medium includes at least one particle and a random copolymer bonded with the particle, wherein the random copolymer has a structural unit originated from a first monomer and a second monomer. The first monomer is selected from at least one or a combination of a group of specific compounds consisting of 2-ethylhexyl acrylate, lauryl methacrylate and octadecyl acrylate etc. and the second monomer is selected from at least one kind of a group of specific compounds composed of 2,2,2 trifluoroethyl acrylate, 2,2,3,3 tetrafluoropropyl methacrylate and 1,1,1,3,3,3-hexafluoroisopropyl acrylate. A method of manufacturing the display medium and an electrophoretic display with the display medium are also provided.

### BACKGROUND OF THE INVENTION

1. Field of the Invention

The invention relates to a display medium, a manufacturing method thereof, and a display. More particularly the invention relates to a display medium adapted for an electrophoretic display, a manufacturing method thereof, and an electrophoretic display.

2. Description of Related Art

With the development of information technology products, manufacturers aim at equipping future displays with features including lightness, thinness, and flexibility. Among the displays, an electrophoretic display (EPD) has attracted great attention.

An EPD mainly uses an external electrical field to control the charged particles within (i.e. electrophoretic particles) in order to display colors of different gray levels. For example, a display medium is constructed through white and black electrophoretic particles, along with a transparent continuous phase solution. Through the electrical field controlling the distribution of the white and the black electrophoretic particles in the continuous phase solution, different gray levels can be displayed. In detail, when the white electrophoretic particles are next to a side of the user, the light of external light source is reflected by the white electrophoretic particles, and the user can see the white color of the electrophoretic particles. When the distribution of the electrophoretic particles are changed, such as black electrophoretic particles being next to a side of the user, the light of external light source will be absorbed by the black electrophoretic particles, and the user will see the black color of the electrophoretic particles.

Because of the bistability characteristic of EPDs, when no additional electrical field is used, the electrophoretic particles can remain at the same depth. In other words, when the EPD maintains the same gray level, or the display image does not change, no power is consumed. Thus, EPDs have the advantage of saving power. In current manufacturing methods of display mediums, for example, uncharged particles and a single type of monomer can be combined to form charged electrophoretic particles. Next the electrophoretic particles are distributed in a continuous phase solution to form a display medium. However, under this configuration, the display medium will have lower reliability, affecting the bistability of the EPD. This also affects the display quality of the EPD.

### SUMMARY OF THE INVENTION

The invention provides a display medium, having favorable reliability.

The invention further provides a method of manufacturing a display medium, for producing the display medium with favorable reliability.

The invention provides an electrophoretic display (EPD), having good display quality.

The invention provides a display medium adapted for an EPD. The display medium includes at least one particle and a random copolymer bonded with the particle. The random copolymer includes a structural unit originated from a first monomer and a second monomer. The first monomer is selected from at least one group of consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate. The second monomer is selected from at least one group consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate.

In an embodiment of the invention, the amount of the second monomer constituted in the random copolymer is 1 molar percent to 50 molar percent.

In an embodiment of the invention, the amount of the second monomer constituted in the random copolymer is 5 molar percent to 15 molar percent.

In an embodiment of the invention, the particles include inorganic particles or organic particles.

In an embodiment of the invention, the particle includes a silane coupling agent, and the particle is bonded to the random copolymer through the silane coupling agent group.

The invention provides a method of manufacturing a display medium adapted for an EPD, wherein the method includes the following steps. At least one particle, a first monomer, and a second monomer are provided. The first monomer is selected from at least one group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate. The second monomer is selected from at least one group consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate. A polymerization reaction is performed by the particle, the first monomer, and the second monomer, so that the first monomer and the second monomer form a random copolymer through the polymerization reaction. The random copolymer is bonded with the particle.

In an embodiment of the invention, in the method of manufacturing the display medium, during the polymerization reaction, the amount of the second monomer relative to the combination of the first monomer and the second monomer is 1 molar percent to 50 molar percent.

In an embodiment of the invention, in the method of manufacturing the display medium, during the polymerization reaction, the amount of the second monomer relative to the combination of the first monomer and the second monomer is 5 molar percent to 15 molar percent.

In an embodiment of the invention, the particle includes a silane coupling agent, and the particle is bonded to the random copolymer formed by the first monomer and the second monomer through the silane coupling agent.

In an embodiment of the invention, the polymerization reaction is performed by the particle, the first monomer, and the second monomer in a nitrogen ambiance.

In an embodiment of the invention, in the method manufacturing the display medium, the method further includes providing a heating temperature during the polymerization reaction by the particle, the first monomer, and the second monomer, wherein the heating temperature is between 50 centigrade to 80 centigrade.

In an embodiment of the invention, the method of manufacturing the display medium further includes distributing the particles and the random copolymer bonded with the particles to a continuous phase solution.

The invention provides an electrophoretic display, including a first electrode layer, a plurality of microcups located on the first electrode layer, a display medium filled in the microcups, and a second electrode layer. The microcups are located between the first electrode layer and the second electrode layer. The display medium includes at least one particle, a random copolymer bonded with the particle, and a continuous phase solution. The random copolymer has a structural unit originated from a first monomer and a second monomer. The first monomer is selected from at least one a group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate. The second monomer is selected from at least one group consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate. The random copolymer bonded with the particle is distributed in the continuous phase solution.

In an embodiment of the invention, the particles of the display medium include black particles and white particles.

In an embodiment of the invention, the second electrode layer includes a plurality of sub-electrodes separated from each other, and the sub-electrodes are respectively located on each microcup.

In an embodiment of the invention, the second electrode layer includes a plurality of sub-electrodes separated from each other, and the sub-electrodes are respectively located near or underneath the partition walls of adjacent microcups to allow the charged particles to move to the sides of the microcups during in-plane switching, so as to expose the bottom layer of the microcups.

The invention provides an electrophoretic display, including a first electrode layer, a plurality of microcups located on the first electrode layer, a display medium filled in the microcups, a second electrode layer, and at least one color base layer. The microcups are located between the first electrode layer and the second electrode layer. The color base layer is located between the second electrode layer and the microcups. The display medium includes at least one particle, a random copolymer bonded with the particle, and a continuous phase solution. The random copolymer has a structural unit originated from a first monomer and a second monomer. The first monomer is selected from at least one group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate. The second monomer is selected from at least one or a combination of a group of specific compounds consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-((trifluoromethyl))hexyl methacrylate. The random copolymer bonded with the particle is dispersed in the continuous phase solution.

In an embodiment of the invention, the second electrode layer includes a plurality of sub-electrodes separated from each other, and each of the sub-electrodes are respectively located near or underneath the partition walls of adjacent microcups to allow the charged particles to move to the sides of the microcups during in-plane switching, so as to expose the bottom layer of the microcups.

Based on the above, in the invention, a random copolymer formed by a first monomer selected from a specific compound and a second monomer selected from a specific compound is bonded with particles. This way, the zeta potential of the particles in a continuous phase solution is improved, so that the particles can quickly move according to an external electrical field. Moreover, favorable reliability is achieved, and thus the EPD can have good display quality.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIGS. 1A and 1B illustrate a process flow for manufacturing a display medium of an embodiment of the invention.

FIG. 2 is a trend diagram showing a zeta potential with respect to different amounts of the second monomer.

FIG. 3 illustrates the bistability performance of the display medium with respect to different amounts of the second monomer.

FIG. 4 illustrates the brightness of the electrophoretic display with respect to different amounts of the second monomer.

FIG. 5 is a schematic cross-sectional view of an electrophoretic display according to an embodiment of the invention.

FIG. 6 is a schematic cross-sectional view of an electrophoretic display according to another embodiment of the invention.

FIG. 7 is a schematic top view of an electrophoretic display according to an embodiment of the invention.

FIG. 8 is a schematic view through an optical microscope of the particles distributed in microcups.

FIG. 9 is a schematic cross-sectional view of an electrophoretic display according to another embodiment of the invention.

FIG. 10 is a schematic cross-sectional view of an electrophoretic display according to another embodiment of the invention.

### DESCRIPTION OF EMBODIMENTS

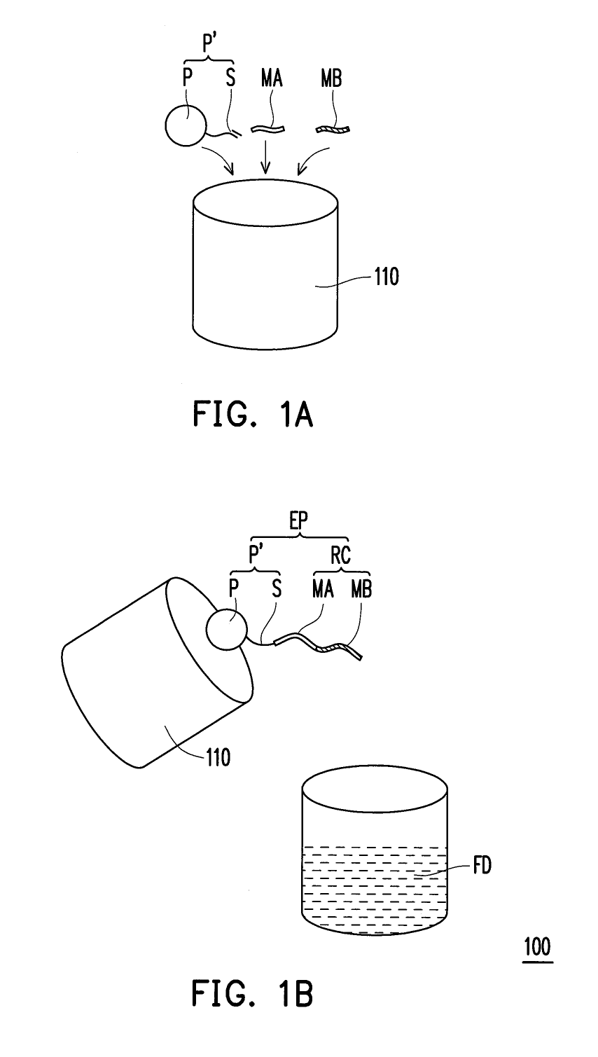

FIGS. 1A and 1B illustrate a process flow for manufacturing a display medium of an embodiment of the invention. Referring to FIG. 1A, first, at least one particle P, a first monomer MA, and a second monomer MB are provided. The first monomer MA is selected from at least one or a combination of a group of specific compounds consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate.

The second monomer is selected from at least one or a combination of a group of specific compounds consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate.

The particle P can be an inorganic particle or an organic particle. In the embodiment, the particle P is, for example, an inorganic particle. The material of the inorganic particle can be selected from at least one of the following: titanium dioxide (TiO₂), zirconium oxide (ZrO₂), silicon dioxide (SiO₂), and aluminium oxides (Al₂O₃). In the embodiment, the particle P can form a particle P′ with a silane coupling agent S through silanzation. The silane coupling agent S can be methacryloxypropyltrimethoxysilane (MSMA).

More specifically, the silane coupling agent S can shown as the following compound:

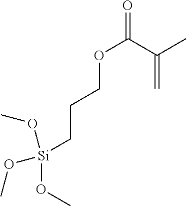 [SMILES: C=C(C)C(=O)OCCC[Si](OC)(OC)OC]

The silane coupling agent S has at least two functional groups on one single molecule for linking particle and polymer, in which one functional group bonds to particle surface, the other functional group bonds to polymer. For example, on this silane coupling agent S, siloxyl group bond to particle surface, and the acrylate functionality will link to a polymer.

Next, a polymerization reaction is performed by the particle P′, the first monomer MA, and the second monomer MB. In the embodiment, the particle P′, the first monomer MA, and the second monomer MB are disposed in a container 110 to perform the polymerization reaction. This way, the first monomer MA and the second monomer MB form a random copolymer RC, and is then bonded with the particle P′. One skilled in the art can select a suitable ambiance and conditions for the polymerization reaction according to the type of product or materials. The invention is not limited thereto. In the container 110 of the embodiment, the amount of the second monomer MB relative to the total amount of the first monomer MA and the second monomer MB is from 1 molar percent to 50 molar percent, or even better from 5 molar percent to 15 molar percent.

In detail, a copolymerization reaction of the particle P′, the first monomer MA, and the second monomer MB is, for example, performed in a nitrogen ambiance. When performing the polymerization reaction, the method can further include a heating process, providing a heating temperature towards the particle P′, the first monomer MA, and the second monomer MB, wherein the heating temperature is between 50 centigrade to 80 centigrade.

Referring to FIG. 1B, after the polymerization reaction, the first monomer MA and the second monomer MB will form a random copolymer RC. The particle P′ is bonded with the random copolymer RC, to form a charged particle (electrophoretic particle) EP. In detail, the particle P′ can be bonded with the random copolymer RC through the silane coupling agent S, and can also be bonded with the random copolymer RC through other functional groups. The invention is not limited thereto. In addition, the embodiment is not limited herein. In other embodiments, the particle can be an organic particle, and can perform similar steps so that the organic particle is bonded with the random copolymer, and achieve similar effects.

Next the electrophoretic particle EP is distributed in a continuous phase solution FD to preliminarily complete the fabrication of a display medium 100.

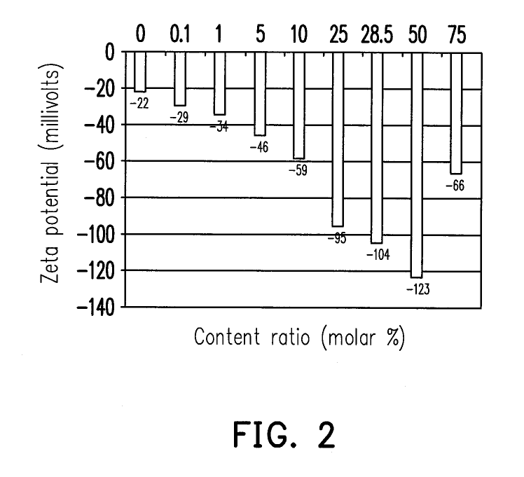

It should be noted that different amounts of the second monomer MB will affect the reliability of the electrophoretic particle EP in the continuous phase solution FD. The following FIGS. 2 to 4 are used to describe effect of the second monomer MB towards the electrophoretic particle EP in the continuous phase solution FD. FIG. 2 is a trend diagram showing a zeta potential with respect to different amounts of the second monomer. The horizontal axis of FIG. 2 shows the different embodiments of content ratio (molar percent) of the second monomer MB. The vertical axis shows the zeta potential (millivolts) of each content ratio of the second monomer MB. The content ratio of the second monomer MB is the amount of the second monomer MB (shown in FIG. 1A) relative to the total amount of the first monomer MA (shown in FIG. 1A) and the second monomer MB.

As seen in FIG. 2, the zeta potential has two trends with respect to the content ratio of the second monomer MB in the continuous phase solution. When the content ratio of the second monomer MB is less than or equal to 50 molar percent, the zeta potential will increase as the content ratio of the second monomer MB in the continuous phase solution increases. When the content ratio of the second monomer MB is greater than 50 molar percent, the zeta potential will decrease as the content ratio of the second monomer MB in the continuous phase solution increases. Since the zeta potential is proportional to the movement velocity of the electrophoretic particle, thus when the content ratio of the second monomer MB is in a range greater than 0 molar percent and less than or equal to 50 molar percent, the movement velocity of the electrophoretic particle will increase as the content ratio of the second monomer MB increases. In other words, suitably adding the second monomer MB, can raise the velocity of the electrophoretic particle shown in the continuous phase solution, so that the electrophoretic particle can quickly move according to the externally added electric field.

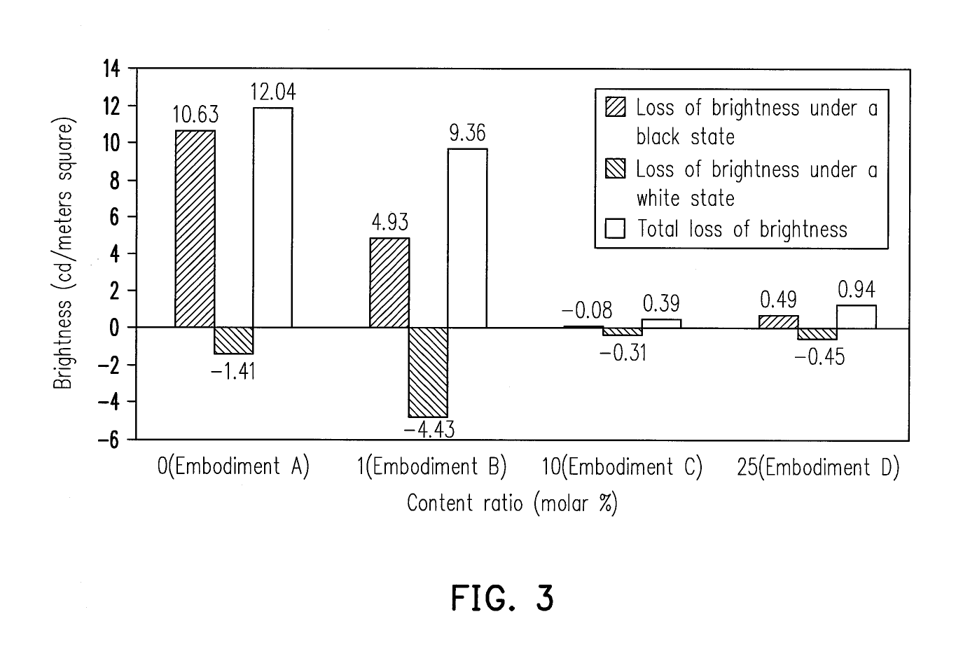

FIG. 3 illustrates the bistability performance of the display medium with respect to different amounts of the second monomer. The horizontal axis shows the content ratio (molar percent) of the amount of the second monomer MB with respect to the total amount of the first monomer MA and the second monomer MB. The vertical axis shows the loss of brightness (cd/meters square). The values of FIG. 3 were obtained through experimentation. The black state of FIG. 3 represents when the display shows an entire black image, and the white state is when the display shows an entire white image. In order to simplify the description, FIG. 3 only shows four content ratios (embodiment A to embodiment D) of the second monomer MB greater than 0 molar percent and less than or equal to 50 molar percent. In embodiment A, the amount of the second monomer MB is 0, which is to say, the display medium does not contain the second monomer MB. In embodiments B, C, and D, the amount of the second monomer MB relative to the total amount of the first monomer MA and the second monomer MB is respectively 1 molar percent, 10 molar percent, and 25 molar percent.

As seen in FIG. 3, when the electric field is removed, the bistability performance of the particles without being introduced the second monomer MB is not good. Under the black state, the loss of brightness is as high as 10.63 (cd/meters square), and under the white state, the loss of brightness is as high as 1.41 (cd/meters square). As the amount of the second monomer MB is increased, the bistability of the particles greatly improve. That is to say, the loss of brightness decreases as the amount of the second monomer MB is increased. This is especially notable in embodiments C and D.

As the amount of the second monomer MB is increased, the bistability of the particles greatly improve (i.e. the loss of brightness in the white state and the loss of brightness in the black state decreases as the amount of the second monomer MB increases). However, the actual brightness of the white state and the black state, do not improve as the second monomer MB increases.

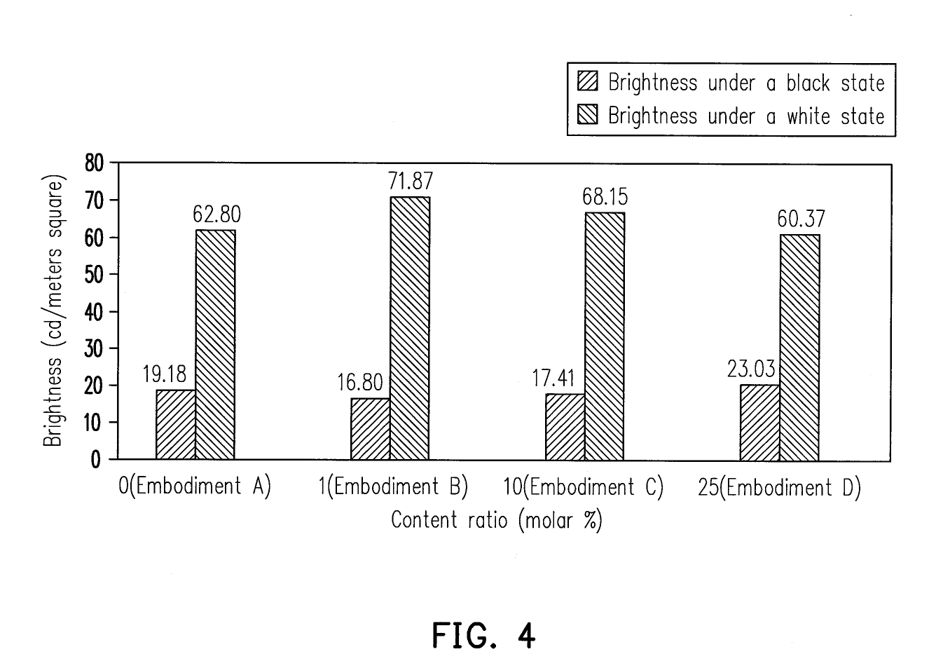

FIG. 4 illustrates the brightness of the electrophoretic display with respect to different amounts of the second monomer. Referring to FIG. 4, FIG. 4 like FIG. 3 only shows four content ratios (embodiment A to embodiment D) of the second monomer MB greater than 0 molar percent and less than or equal to 50 molar percent. In addition, the vertical axis of FIG. 4 shows the brightness (cd/meters square), and the horizontal axis shows content ratio (molar percent) of the amount of the second monomer MB relative to the total amount of the first monomer MA and the second monomer MB. The values shown in FIG. 4 were obtained through experimentation. Similarly, in embodiment A, the amount of the second monomer MB is 0, which is to say, the display medium does not contain the second monomer MB. In embodiments B, C, and D, the amount of the second monomer MB relative to the total amount of the first monomer MA and the second monomer MB is respectively 1 molar percent, 10 molar percent, and 25 molar percent.

When the display is driven under a black state, the lower the brightness is, the higher the degree of blackness is shown by the display. On the other hand, when the display is driven under a white state, the higher the brightness is, the higher the degree of whiteness is shown by the display. As seen in FIG. 4, for the particles without the second monomer MB (embodiment A), the brightness under the white state is as high as 62.80 (cd/meters square), and under the black state, the brightness is as high as 19.18 (cd/meters square). When the second monomer MB is added (embodiments B and C), the brightness under the white state and the brightness under the black state are much better than compared to when the second monomer MB is not added (embodiment A). That is to say, the brightness under the white state is increased, and the brightness under the black state is decreased.

However, when the amount of the second monomer MB is increased to 25 molar percent (embodiment D), even though the bistability is very good (see FIG. 3, where the loss of brightness under the white state and the black state are relatively low), the brightness under the white state and the black state are tend to unfavorable. In detail, the brightness 60.37 (cd/meters square) under the white state in embodiment D is lower than the brightness 62.80 (cd/meters square) under the white state of embodiment A. In other words, the whiteness shown by the display in embodiment D is not as good. In addition, the brightness 23.03 (cd/meters square) under the black state in embodiment D is higher than the brightness 19.18 (cd/meters square) under the black state of embodiment A. In other words, the blackness shown by the display in embodiment D is not as good. Thus, the brightness different (i.e. the difference between the brightness under the white state and the brightness under the black state) of when the second monomer MB is increased to 25 molar percent (embodiment D), is apparently worse than that of when the second monomer MB is not added (embodiment A).

Referring to FIG. 3 and FIG. 4, even though introducing the second monomer MB improves bistability and the loss of brightness, however, the display quality of the display also needs to consider the brightness shown under the white state and the black state. As seen in embodiment D, the bistability performance and the loss of brightness are good, however, the brightness under the white state and the black state are inferior to the embodiment A without introducing the second monomer MB. Further, compared to embodiments C and D, even though embodiment B has better brightness under the white state and the black state, meaning the brightness under the white state is higher, and the brightness under the black state is lower, however when compared to embodiments C and D, the bistability and loss of brightness in embodiment B is inferior. After a period of time without an external electrical field, the loss of brightness in the white state and the black state of embodiment B will be greater than that of embodiments C or D. Thus, the amount of the second monomer MB relative to the total amount of the first monomer MA and the second monomer MB is better between the embodiments B to D, or 5 molar percent to 15 molar percent.

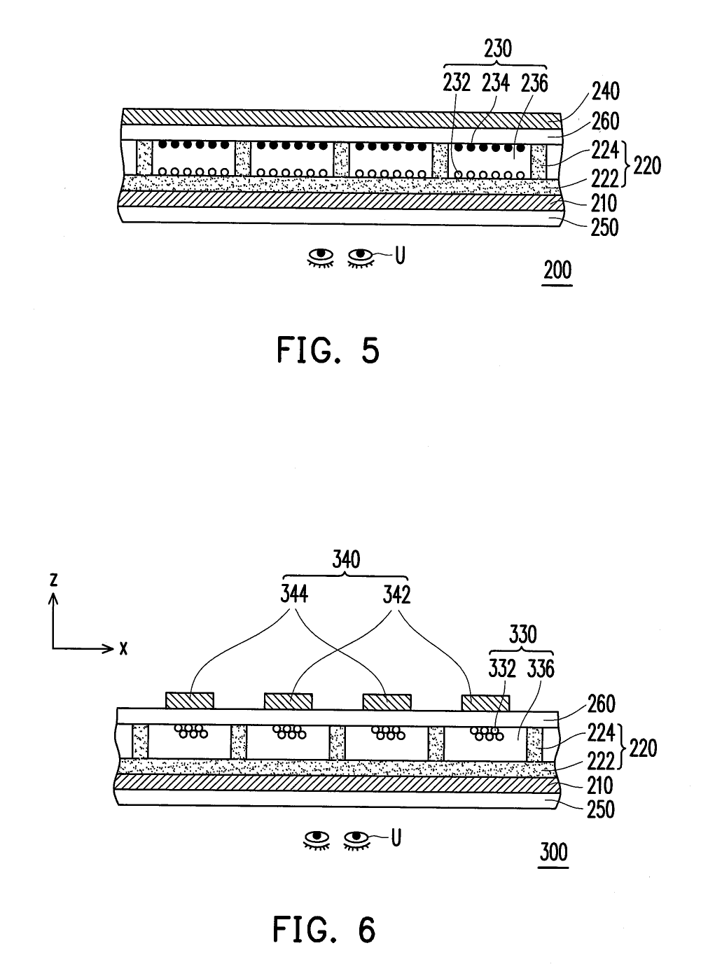

It should be noted that the display medium of the embodiment can be adapted to an EPD, so as to display images. The following will describe FIGS. 5 to 7, which shows a structure of an EPD applying the display medium, and the operating principle thereof. It should be noted that for simplicity in drawing, FIG. 5 to FIG. 7 omitted drawing the silane coupling agent and the random copolymer of the electrophoretic particles, and only showed the electrophoretic particles with a sphere shape. However, the embodiment does not limit the shape of the electrophoretic particles.

FIG. 5 is a schematic cross-sectional view of an electrophoretic display according to an embodiment of the invention. Referring to FIG. 5, the electrophoretic display 200 of the embodiment includes a first electrode layer 210, a plurality of microcups 220 located on the first electrode layer 210, a display medium 230 filled in the microcups 220, and a second electrode layer 240. The microcups 220 are located between the first electrode layer 210 and the second electrode layer 240. The material of the first electrode 210 is, for example, metallic oxide, such as indium tin oxide, indium zinc oxide, aluminum tin oxide, aluminum zinc oxide, indium germanium zinc oxide, or any other appropriate oxides, or a combination of at least two thereof.

In the embodiment, the microcups 220 include a bottom portion 222 and a plurality of support portions 224. The support portions 224 are located between the bottom portion 222 and the second electrode layer 240. The support portions 224 and the bottom portions 222 form a plurality of micro cup shape structures.

The display medium 230 is manufactured through the aforementioned method of manufacture. In brief, the display medium 230 includes the particle P′ (shown in FIG. 1B), the electrophoretic particle EP (shown in FIG. 1B) formed by the particle P′ being bonded with the random copolymer RC (shown in FIG. 1B), and a continuous phase solution FD (shown in FIG. 1B). In the embodiment, the particles in the display medium 230 include white particles 232 and black particles 234. The white particles 232 and the black particles 234 are, for example, respectively charged particles with opposite charges formed from the polymerization of different monomers. In addition, the white particles 232 and the black particles 234 can be dispersed in a transparent continuous phase solution 236.

It should be noted that the white particles 232 and the black particles 234 of FIG. 5 are only shown as examples. The embodiment does not limit the dimensions and the quantity of the white particles 232 and the black particles 234. Of course, the embodiment also does not limit the colors of the particles in each microcup 220 or the colors of the continuous phase solution 236 in the microcup 220. One skilled in the art can replace the colors of the particles and the continuous phase solution 236 with other suitable colors. In other words, the colors of the particles of each of the microcups can be a single color, and two colors. The color of the continuous phase solution in each of the microcups can be black, white, or another color. For example, a display medium can be constructed through white particles and a black continuous phase solution. Or, the display medium can be constructed through white particles respectively distributed in red, green, and blue continuous phase solutions. Of course, the display medium can be constructed through white and black particles respectively distributed in red, green, and blue continuous phase solutions.

The second electrode layer 240 and the first electrode layer 210 are respectively located on the two opposite sides of the microcups 220. In the embodiment, the second electrode layer 240 is, for example, an entire surface electrode structure. However, the embodiment does not limit the structure of the second electrode. In other embodiments, the second electrode can also be a plurality of strip shaped electrodes separated from each other.

In actual implementation, the electrophoretic display 200 can further include a substrate 250 and an encapsulation layer 260. The first electrode layer 210 is disposed on the substrate 250, and the support portions 224 of the microcups 220 are further located between the bottom portion 222 and the encapsulation layer 260. In addition, the encapsulation layer 260 is sealed between the microcups 220 and the second electrode layer 240, so as to protect the display medium 230 in the microcups 220, and prevent the external environment from affecting the display medium 230. The material of the substrate 250 is glass, quartz, organic polymers, plastic, or other suitable materials. In the embodiment, the substrate 250 is a soft material, such as polyethylene terephthalate (PET). Thus, the EPD 200 can not only be manufactured into general rigid material displays (such as e-books), the EPD 200 also can also be manufactured into flexible displays, such as smart cards or price tags.

By providing a voltage difference between the first electrode layer 210 and the second electrode layer 240, the black particles 234 and the white particles 232 are driven by the electric field between the first electrode layer 210 and the second electrode layer 240. This changes the distribution condition between the black particles 234 and the white particles 232 in the microcups 220, so that the EPD 200 displays different images (gray level). In detail, when the black particles 234 and the white particles 232 are driven by the electric field, because the black particles 234 and the white particles 232 have opposite charges, they will move in different directions. The distributions of the particles in the microcups 220 closer to a side of the user U are the picture color of what the user sees. For example, when the white particles 232 of the microcups 220 are on a side closer to the user U, the ambient light will be reflected by the white particles 232, so that the user U sees a white picture. In contrast, when the black particles 234 of the microcups 220 are on a side closer to the user U, the ambient light will be absorbed by the black particles 234, so that the user U sees a black picture. Similarly, when a mixture of white particles 232 and black particles 234 of the microcups 220 are on a side closer to the user U, the user U sees a gray picture. In other words, by adjusting the distribution of the black particles 234 and the white particles 232 within each of the microcups 220, the EPD 200 can display different gray levels.

In order to more precisely control the distribution of the particles (i.e. electrophoretic particles) in each microcup, the first electrode layer and the second electrode layer can have different structures. For example, the first electrode layer and the second electrode layer can respectively include electrodes that are separated from each other (such as strip shaped electrodes), and the first electrode layer and the second electrode layer can be alternately configured. Or, the first electrode layer can be an entire surface electrode and the second electrode layer can be divided to sub-electrodes that are electrically separated from each other. The following will further describe the structure and configuration of the electrode layers through FIG. 6 to FIG. 9.

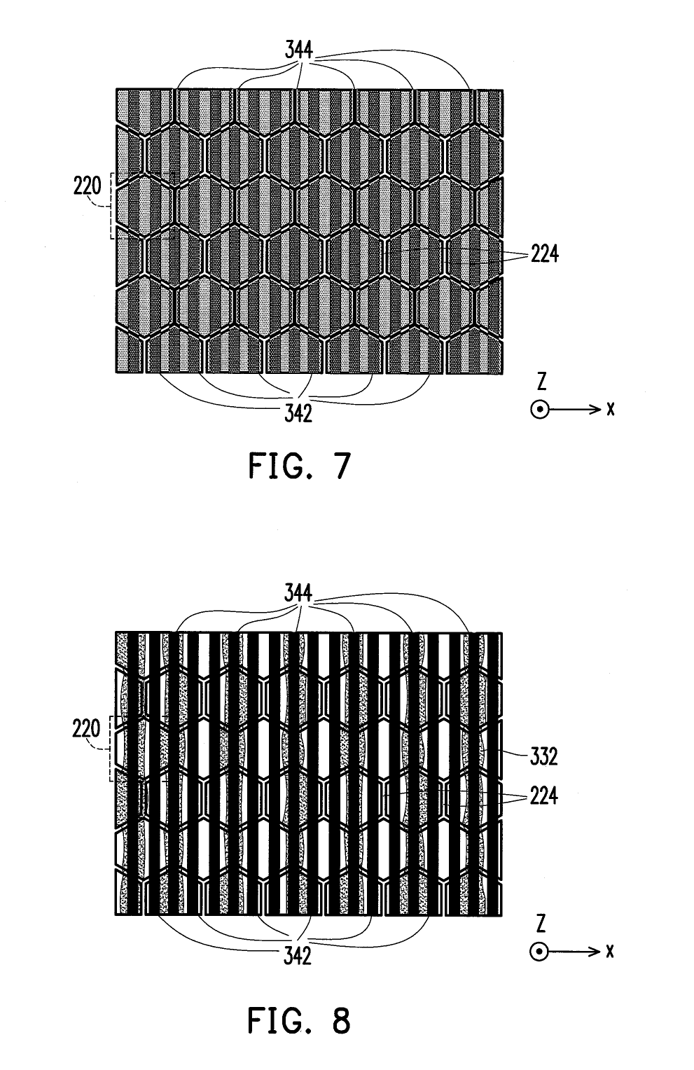

FIG. 6 is a schematic cross-sectional view of an electrophoretic display according to another embodiment of the invention. FIG. 7 is a schematic top view of an electrophoretic display according to an embodiment of the invention. Referring to FIG. 6, the EPD 300 of the embodiment is similar to the EPD 200 of FIG. 5. Identical or similar reference numerals represent identical or similar elements. The difference between the two embodiments is that the second electrode layer 340 of the EPD 300 includes a plurality of sub-electrodes 342, 344 separated from each other, and the sub-electrodes 342, 344 are respectively located on each microcup 220. In the embodiment, the sub-electrodes 342, 344 are, for example, respectively located on the microcups 220 between two adjacent support portions 224. In addition, the display medium 330 includes white particles 332 accompanied with a black continuous phase solution 336. Of course, the embodiment does not limit the colors or quantity of the particles of each microcup, or the colors of the continuous phase solution. In other words, when the second electrode layer is a structure of multiple sub-electrodes separated from each other, the display medium can be white particles and black particles accompanied with a transparent continuous phase solution.

In addition, the embodiment does not limit the amount of the sub-electrodes 342, 344 between two adjacent support portions 224. Referring to FIG. 6 and FIG. 7, the amount of the sub-electrodes 342, 344 between two adjacent support portions 224 can be greater than one. With this structure, by providing a voltage difference between the sub-electrodes 342, 344 separated from each other and the first electrode layer 210, the distribution of the white particles 332 in the microcups 220 can be controlled. In detail, by adjusting the voltage difference between the second electrode layer 340 and the first electrode layer, the distribution of the white particles 332 in the microcups 220 along a first direction Z can be controlled. By adjusting the voltage difference between the sub-electrode 342 and the sub-electrode 344, the distribution of the white particles 332 in the microcups 220 along a second direction X can be controlled, further allowing the EPD 300 to display different gray levels.

FIG. 8 is a schematic view through an optical microscope of the particles distributed in microcups. Referring to FIG. 8, under an optical microscope, the light at the clustering area of the particles is shielded, and so a black image is displayed under the optical microscope. In other words, from FIG. 8, it can be seen that by providing a voltage difference between the sub-electrode 342 and the sub-electrode 344, the distribution of the white particles 332 in the microcups 220 along the second direction X can be controlled. In FIG. 8, the white particles 332 are successfully gathered beside the sub-electrode 342.

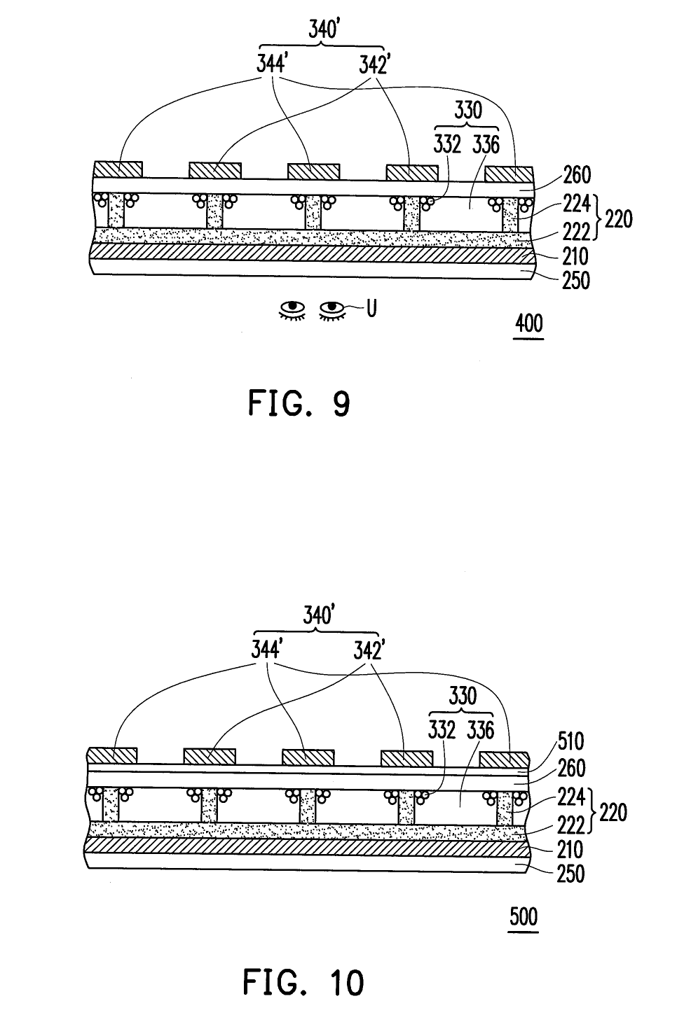

Further, in other embodiments, the sub-electrodes 342, 344 can also be disposed in other areas of the microcups 220. FIG. 9 is a schematic cross-sectional view of an electrophoretic display according to another embodiment of the invention. Referring to FIG. 9, the EPD 400 of the embodiment is similar to the EPD 300 of FIG. 6. Identical or similar reference numerals represent identical or similar elements. The difference between the two embodiments is that the sub-electrodes 342′, 344′ of the embodiment is located on partition walls of adjacent microcups 220. Specifically, the sub-electrodes 342′, 344′ are respectively located opposited to the position of each support portion 224.

With this structure, the white particles 332 can be controlled by the electric field and gather beside the support portion 224, so as to expose the structure behind the encapsulation layer 260. In other words, when the continuous phase solution 336 is replaced as a transparent solution, and the white particles 332 are controlled by the electric field to gather beside the support portions 224, the second electrode layer 340′ behind the encapsulation layer 260 is seen by the user U. With this structure, a color base layer can be further disposed between the encapsulation layer 260 and the second electrode layer 340′, so that the EPD 400 can display different colors.

FIG. 10 is a schematic cross-sectional view of an electrophoretic display according to another embodiment of the invention. Referring to FIG. 10, the EPD 500 of the embodiment is similar to the EPD 400 of FIG. 9. Identical or similar reference numerals represent identical or similar elements. The difference between the two embodiments is that the EPD 500 of the embodiment further includes a color base layer 510 located between the second electrode layer 340′ and the microcups 220. Specifically, the color base layer 510 is disposed between the encapsulation layer 260 and the second electrode layer 340′. Of course, the embodiment does not limit the colors or quantity of the particles, or the structure of each electrode layer (the first electrode layer 210 and the second electrode layer 340′). In addition, the color base layer not only can be a single colored structure, but can also be a multi-colored structure. In other words, the EPD 500 can not only be manufactured into black and white displays, but can also be manufactured into single or multi-colored displays.

To sum up, in the invention, a random copolymer formed by a first monomer selected from a specific compound and a second monomer selected from a specific compound is bonded with particles. This way, the zeta potential of the particles in a continuous phase solution is improved, so that the particles can quickly move according to an external electrical field. Moreover, favorable reliability is achieved, and the EPD can have good display quality. In addition, in the embodiments, by changing the structure and configuration of the second electrode layer, and accompanying a color base layer, the EPD can be colorized.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display medium, adapted for an electrophoretic display, the display medium comprising:
at least one particle; and
a random copolymer, bonded with the at least one particle, wherein the random copolymer includes a structural unit originated from a first monomer and a second monomer, wherein the first monomer is selected from at least one group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate, and the second monomer is selected from at least one group consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate.

2. The display medium as claimed in claim 1, wherein an amount of the second monomer constituted in the random copolymer is 1 molar percent to 50 molar percent.

3. The display medium as claimed in claim 1, wherein an amount of the second monomer constituted in the random copolymer is 5 molar percent to 15 molar percent.

4. The display medium as claimed in claim 1, wherein the at least one particle comprises at least one organic particle or at least one inorganic particle.

5. The display medium as claimed in claim 1, wherein the at least one particle comprises a silane coupling agent and the at least one particle is bonded to the random copolymer through the silane coupling agent.

6. A method of manufacturing a display medium, wherein the display medium is adapted for an electrophoretic display, wherein the method of manufacturing the display medium comprises:
providing at least one particle, a first monomer, and a second monomer, wherein the first monomer is selected from at least one group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate, and the second monomer is selected from at least one group consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate; and
a polymerization reaction is performed by the at least one particle, the first monomer, and the second monomer, so that the first monomer and the second monomer form a random copolymer through the polymerization reaction, and the random copolymer is bonded with the at least one particle.

7. The method of manufacturing the display medium as claimed in claim 6, wherein when the polymerization reaction is performed, an amount of the second monomer relative to a total amount of the first monomer and the second monomer is 1 molar percent to 50 molar percent.

8. The method of manufacturing the display medium as claimed in claim 6, wherein when the polymerization reaction is performed, an amount of the second monomer relative to a total amount of the first monomer and the second monomer is 5 molar percent to 15 molar percent.

9. The method of manufacturing the display medium as claimed in claim 6, wherein the at least one particle includes a silane coupling agent, and the at least one particle is bonded to the random copolymer formed by the first monomer and the second monomer through the silane coupling agent.

10. The method of manufacturing the display medium as claimed in claim 6, wherein the polymerization reaction by the at least one particle, the first monomer, and the second monomer is performed in a nitrogen ambiance.

11. The method of manufacturing the display medium as claimed in claim 6, further comprising providing a heating temperature during the polymerization reaction by the at least one particle, the first monomer, and the second monomer, wherein the heating temperature is between 50 centigrade to 80 centigrade.

12. The method of manufacturing the display medium as claimed in claim 6, further comprising distributing the at least one particle and the random copolymer bonded with the at least one particle to a continuous phase solution.

13. An electrophoretic display, comprising:
a first electrode layer;
a plurality of microcups, located on the first electrode layer;
a display medium, filled into the microcups, wherein the display medium comprises:
at least one particle;
a random copolymer, bonded with the at least one particle, wherein the random copolymer comprises a structural unit originated from a first monomer and a second monomer, wherein the first monomer is selected from at least one group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate, and the second monomer is selected from at least one group of consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate; and
a continuous phase solution, wherein the random copolymer bonded with the at least one particle is distributed in the continuous phase solution; and
a second electrode layer, wherein the microcups are located between the first electrode layer and the second electrode layer.

14. The electrophoretic display as claimed in claim 13, wherein the at least one particle of the display medium comprises at least one black particle and at least one white particle.

15. The electrophoretic display as claimed in claim 13, wherein the second electrode layer comprises a plurality of sub-electrodes separated from each other, wherein the sub-electrodes are respectively located on each of the microcups.

16. The electrophoretic display as claimed in claim 13, wherein the second electrode layer comprises a plurality of sub-electrodes separated from each other, wherein each of the sub-electrodes are respectively located on near or underneath the partition walls of adjacent microcups to allow the charged particles to move to the sides of the microcups during in-plane switching, so as to expose the bottom layer of the microcups.

17. An electrophoretic display, comprising:
a first electrode layer;
a plurality of microcups, located on the first electrode layer;
a display medium, filled into the microcups, wherein the display medium comprises:
at least one particle;
a random copolymer, bonded with the at least one particle, wherein the random copolymer comprises a structural unit originated from a first monomer and a second monomer, wherein the first monomer is selected from at least one o a group consisting of 2-ethylhexyl acrylate (EHA), 2-ethylhexyl methacrylate (EHMA), 2-methylhexyl acrylate (MHA), 2-methylhexyl methacrylate (MHMA), lauryl methacrylate, lauryl acrylate, tetradecyl methacrylate, tetradecyl acrylate, hexadecyl methacrylate, hexadecyl acrylate, octadecyl mechacrylate, and octadecyl acrylate, and the second monomer is selected from at least one or a combination of a group of specific compounds consisting of 2,2,2 trifluoroethyl acrylate, 2,2,3,3 tetrafluoropropyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate, 2,2,3,3-tetrafluoropropyl acrylate, 2,2,3,4,4,4-hexafluorobutyl methacrylate, 2,2,3,3,4,4,4-heptafluorobutyl methacrylate, 2,2,3,3,4,4,5,5-octafluoropentyl acrylate, 2,2,3,3,4,4,5,5-octafluoropentyl methacrylate, 2,2,3,3,4,4,5,5,6,6,7,7-dodecafluoroheptyl acrylate, and 3,3,4,4,5,6,6,6-octafluoro-5-(trifluoromethyl)hexyl methacrylate; and
a continuous phase solution, wherein the at least one particle and the random copolymer bonded with the at least one particle are distributed in the continuous phase solution;
a second electrode layer, wherein the microcups are located between the first electrode layer and the second electrode layer; and
at least one color base layer, located between the second electrode layer and the microcups.

18. The electrophoretic display as claimed in claim 17, wherein the second electrode layer comprises a plurality of sub-electrodes separated from each other, wherein the sub-electrodes are respectively located on near or underneath the partition walls of adjacent microcups to allow the charged particles to move to the sides of the microcups during in-plane switching, so as to expose the bottom layer of the microcups partition wall.
